(19) United States
(12) Patent Application Publication
(10) Pub. No.: US 2014/0300625 A1
(43) Pub. Date: Oct. 9, 2014

(54) DISPLAY DEVICE AND METHOD OF COMPENSATING COLORS OF THE DISPLAY DEVICE

(71) Applicant: Samsung Display Co., LTD., Yongin-City (KR)

(72) Inventors: Byung-Ki Chun, Yongin-City (KR); Yong-Seok Choi, Yongin-City (KR); Dong-Wook Yang, Yongin-City (KR)

(73) Assignee: Samsung Display Co., LTD, Yongin-City (KR)

(21) Appl. No.: 14/010,485

(22) Filed: Aug. 26, 2013

(30) Foreign Application Priority Data
Apr. 3, 2013 (KR) 10-2013-0036444

(51) Int. Cl. G09G 5/02

(52) U.S. Cl. CPC G09G 5/02
USPC 345/600

(57) ABSTRACT

Provided is a display device including: a display panel comprising a plurality of pixels, each of the plurality of pixels configured to display one of three primary colors; and a color compensator configured to receive color data comprising gradation data corresponding to each of the three primary colors and configured to increase chroma of a color in which the three primary colors are mixed, by compensating a color of the color data based on color ratios of the three primary colors.

### CROSS-REFERENCE TO RELATED APPLICATION

This application claims priority to and the benefit of Korean Patent Application No. 10-2013-0036444, filed on Apr. 3, 2013, in the Korean Intellectual Property Office, the disclosure of which is incorporated herein in its entirety by reference.

### BACKGROUND

1. Field

Embodiments of the present invention relate to a display device and a method of compensating colors of the display device.

2. Description of the Related Art

In general, a display screen of a portable terminal, such as one of a mobile phone or a personal digital assistant (PDA), allows users to view desired content anytime and anywhere. However, a display screen is exposed to various environments because it is portable and mobile. In addition, the viewability of an image displayed on a display screen may vary according to environment factors such as luminance or color temperature. In particular, when a luminance of an image displayed on a display screen is higher than that of its surroundings, the viewability of the image displayed on the display screen may decrease abruptly.

### SUMMARY

Aspects of embodiments of the present invention are directed toward a display device in which viewability of an image in a high-luminance external environment increases, and a method of compensating colors of the display device.

According to an embodiment of the present invention, there is provided a display device including: a display panel comprising a plurality of pixels, each of the plurality of pixels configured to display one of three primary colors; and a color compensator configured to receive color data comprising gradation data corresponding to each of the three primary colors and configured to increase chroma of a color in which the three primary colors are mixed, by compensating a color of the color data based on color ratios of the three primary colors.

The color compensator may be configured to calculate the color ratios based on luminance values of the three primary colors.

The color compensator may be configured to select a color having a highest color ratio among the three primary colors and to increase a luminance of the selected color.

The color compensator may be configured to progressively increase the luminance of the selected color as the color ratio of the selected color increases.

The color compensator may be configured to increase a luminance of a color among the three primary colors having a color ratio equal to or greater than a reference value.

The color compensator may be configured to progressively increase the luminance of the color as the color ratio of the color having the color ratio equal to or greater than the reference value increases.

The reference value may be a predetermined value or a value set according to an external luminance.

The color compensator may be configured to increase a luminance of a first color among the three primary colors having a color ratio equal to or greater than a first reference value, and configured to reduce a luminance of a second color having a color ratio equal to or less than a second reference value less than the first reference value.

The color compensator may be configured to increase the luminance of the first color as the color ratio of the first color increases, and may be configured to reduce the luminance of the second color as the color ratio of the second color decreases.

The display device may further include an external light sensor configured to sense an external luminance.

The color compensator may be configured to perform color compensation of the color data when external luminance data provided from the external light sensor is equal to or greater than a reference value.

Each of the plurality of pixels may include an organic light-emitting diode.

According to another embodiment of the present invention, there is provided a display device including: a display panel including a plurality of pixels, each of the plurality of pixels configured to display one of a plurality of colors including red, green, and blue colors; a data driver configured to provide pixel data corresponding to received color data to the display panel; an external light sensor configured to sense an external luminance; and a controller configured to receive color data comprising gradation data corresponding to each of the plurality of colors, and configured to perform image processing on the color data and to output the color data to the data driver, wherein the controller includes a color compensator configured to compensate a color of the color data by increasing chroma of a color in which the plurality of colors are mixed based on color ratios of the plurality of colors.

The color compensator may be configured to increase a luminance of a color among the plurality of colors having a color ratio equal to or greater than a reference value.

The controller and the data driver may be integrated as a single semiconductor chip.

According to another embodiment of the present invention, there is provided a method of compensating a color of a display device, the method including: receiving color data including gradation data of each of three primary colors including red, green, and blue colors mixed to form a single color; converting the gradation data of each of the three primary colors to luminance data; compensating luminance data of at least one color among the three primary colors such that chroma of the single color increases based on color ratios of the three primary colors calculated using the luminance data; converting the compensated luminance data to gradation data; and outputting color-compensated color data.

The compensating luminance data may include: determining color ratios of the three primary colors; calculating a luminance variation ratio of the at least one color based on the color ratios; and compensating a luminance of the at least one color by applying the luminance variation ratio.

In the calculating a luminance variation ratio, an increasing ratio may be calculated with respect to a color among the three primary colors having a color ratio equal to or greater than a reference value, such that the luminance is progressively increased as a color ratio increases.

In the calculating a luminance variation ratio, a luminance increasing ratio by which luminance is progressively increased as a color ratio increases, with respect to a first color among the three primary colors having a color ratio equal to or greater than a first reference value, and a luminance reduction ratio by which luminance is progressively reduced as a color ratio decreases, with respect to a second color having a color ratio equal to or less than a second reference value lower than the first reference value, may be calculated.

The method may further include measuring an external luminance, wherein the compensating luminance data is performed when the measured external luminance is equal to or greater than a reference value.

### BRIEF DESCRIPTION OF THE DRAWINGS

The above and other features and aspects of the present invention will become more apparent by describing in detail example embodiments thereof with reference to the attached drawings in which:

FIG. 1 is a schematic view of a display device according to an embodiment of the present invention;

FIG. 2 is a block diagram illustrating a color compensation unit shown in FIG. 1 according to an embodiment of the present invention;

FIG. 3 is a graph showing calculation of a luminance variation ratio according to an embodiment of the present invention;

FIG. 4 is a graph showing calculation of a luminance variation ratio according to another embodiment of the present invention;

FIG. 5 is a block diagram illustrating a color compensation unit shown in FIG. 1 according to another embodiment of the present invention;

FIG. 6A is a circuit diagram illustrating a pixel illustrated in FIG. 1 according to an embodiment of the present invention, and FIG. 6B is a driving waveform diagram of the pixel illustrated in FIG. 6A;

FIG. 7 is a schematic flowchart illustrating a method of compensating colors of a display device according to an embodiment of the present invention;

FIG. 8 is a detailed flowchart illustrating a method of compensating luminance data as described in FIG. 7;

FIG. 9 is a schematic flowchart illustrating a method of compensating colors of a display device according to another embodiment of the present invention; and

FIG. 10 illustrates an application example of various electronic products in which a display device according to an embodiment of the present invention is mounted.

### DETAILED DESCRIPTION

The present invention will now be described more fully with reference to the accompanying drawings, in which example embodiments of the present invention are shown. Embodiments of the present invention may, however, be embodied in many different forms and should not be construed as being limited to the embodiments set forth herein; rather, these embodiments are provided so that this disclosure will be thorough and complete, and will fully convey the concept of embodiments of the present invention to one of ordinary skill in the art. It should be understood, however, that there is no intent to limit example embodiments of the present invention to the particular forms disclosed, but conversely, example embodiments of the present invention are to cover all modifications, equivalents, and alternatives falling within the spirit and scope of the present invention. In the drawings, like reference numerals denote like elements and the sizes of elements may be exaggerated or reduced for clarity of explanation.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Also, while such terms as “first”, “second”, etc., may be used to describe various components, such components should not be limited to the above terms. The above terms may be used only to distinguish one component from another. For example, without departing from the scope of the present invention, a first element may be referred to as a second element, and similarly, a second element may also be referred to as a first element.

Unless defined differently, all terms used in the description including technical and scientific terms have the same meaning as generally understood by one of ordinary skill in the art. Terms as defined in a commonly used dictionary should be construed as having the same meaning as that in an associated technical context, and unless defined in the description, the terms are not ideally or excessively construed as having formal meaning.

Expressions such as “at least one of,” when preceding a list of elements, modify the entire list of elements and do not modify the individual elements of the list.

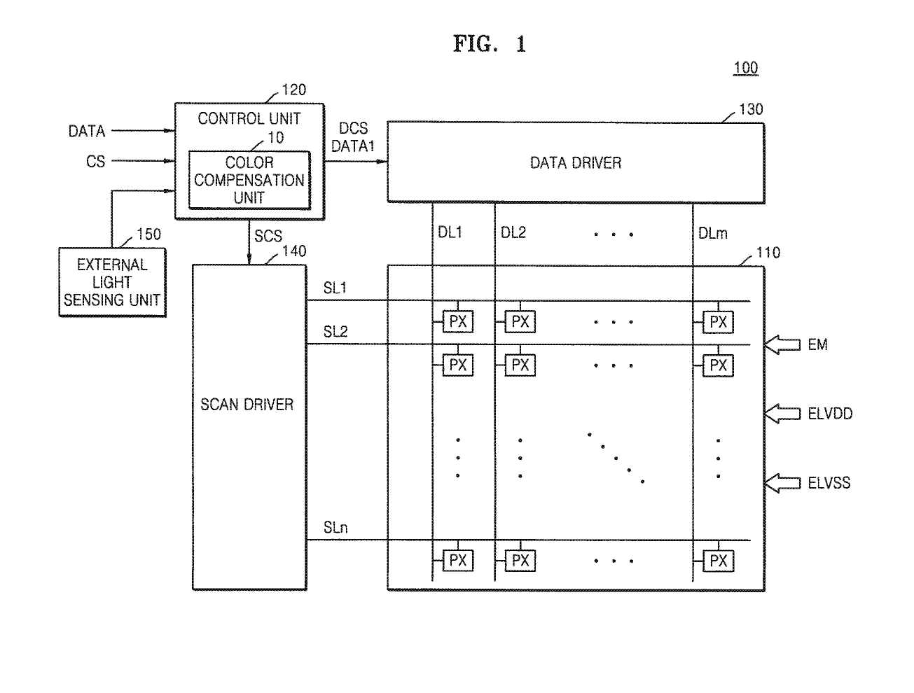

FIG. 1 is a schematic view of a display device 100 according to an embodiment of the present invention.

Referring to FIG. 1, the display device 100 includes a display panel 110 that displays an image, a control unit (or controller) 120 that drives the display panel 110, a data driver 130, and a scan driver 140. Also, the display device 100 may further include an external light sensing unit (or external light sensor) 150 that senses a luminance of an external environment.

The control unit 120, the data driver 130, and the scan driver 140 may be formed as different semiconductor chips, or may be integrated as a single semiconductor chip. Also, the control unit 120 and the data driver 130 may be integrated as a single semiconductor chip, and the scan driver 140 may be formed on the same substrate as the display panel 110 is formed on.

The display panel 110 includes a plurality of pixels PX that are arranged in a matrix form where a plurality of scan lines SL1 through SLn, which are arranged in rows, cross a plurality of data lines DL1 through DLm, which are arranged in columns. The pixels PX receive a scan signal and a data signal from the scan lines SL1 through SLn and the data lines DL1 through DLm, respectively.

As illustrated in FIG. 1, the display panel 110 may be a light-emitting diode (LED) panel that is driven by receiving an emissive signal (or emission signal) EM, a driving voltage ELVDD, and a ground voltage ELVSS. However, the display panel 110 is not limited thereto. The display panel 110 may be any one of various suitable panels, and may be, for example, one of a liquid crystal display (LCD), an electrochromic display (ECD), a digital mirror device (DMD), an actuated mirror device (AMD), a grating light value (GLV), a plasma display panel (PDP), an electro luminescent display (ELD), an LED display, and a vacuum fluorescent display (VFD).

The plurality of pixels PX included in the display panel 110 may each display one of a plurality of colors, such as red, green, or blue. Hereinafter, for convenience of description, it will be assumed that the plurality of pixels PX displays one of red, green, or blue, which are the three primary colors of light.

The pixels PX may display red, green, or blue color, and the pixels PX displaying red, the pixels PX displaying green, and the pixels PX displaying blue may be sequentially and repeatedly arranged (e.g., arranged in a pattern). A user may perceive single color light, in which red, green, and blue light are mixed, that is displayed by adjacent pixels PX. For example, a data signal with a high gradation may be applied to each of the pixels PX displaying red, green, and blue so that when the pixels PX emit light, red, green, and blue light of the high gradation, which are output from the pixels PX, may be mixed and perceived as white color light. According to another example, a high-gradation data signal may be applied to pixels displaying red and green color, and a low-gradation data signal may be applied to a pixel displaying blue so that when the pixels PX emit light, the high-gradation red light and green light and the low-gradation blue light, which are output from the pixels PX, may be mixed to be perceived as yellow light.

The data driver 130 may receive a data control signal DCS and color data DATA1 from the control unit 120, and supply a data signal corresponding to the color data DATA1 to the pixels PX via the data lines DL1 through DLm, in response to the data control signal DCS. In embodiments of the present invention, the data driver 130 converts the received color data DATA1 into a data signal in the form of a voltage or a current.

The scan driver 140 receives a scan control signal SCS from the control unit 120 to generate a scan signal. Also, the scan driver 140 may supply the generated scan signal to the pixels PX via the scan lines SL1 through SLn. The pixels PX may be sequentially selected by each row according to the scan signal, thereby providing a data signal to the pixels PX (e.g., providing a data signal to the pixels PX row by row).

The control unit 120 generates signals, namely, the data control signal DCS and the scan control signal SCS for controlling the data driver 130 and the scan driver 140 based on color data DATA and a control signal CS received from the outside, respectively. The controller 120 provides the data control signal DCS and the scan control signal SCS to the data driver 130 and the scan driver 140, respectively. The data signal CS may be, for example, timing signals, such as a vertical synchronization signal Vsync, a horizontal synchronization signal Hsync, a clock signal CLK, and a data enable signal DE. Also, the control unit 120 may provide color data DATA1, obtained by converting color data DATA received from the outside, to the data driver 130.

Also, the color data DATA may include gradation data corresponding to a plurality of colors including red, green, and blue colors, and the control unit 120 may perform image processing on the color data DATA according to an external luminance to provide the color data DATA1 to the data driver 130. Here, the control unit 120 may include a color compensation unit (or color compensator) 10 for performing image processing on the color data DATA. Also, the control unit 120 may include a graphic RAM (GRAM) and may temporarily store color data DATA of a frame received from the outside in the GRAM. The color data DATA stored in the GRAM may be output to the data driver 130 according to a display timing or may be provided to the color compensation unit 10 when the color compensation unit 10 performs image processing.

Based on a color ratio of red, green, and blue colors shown by the color data DATA, the color compensation unit 10 may increase a chroma of a color in which the above three primary colors are mixed, thereby compensating the colors of the color data DATA. A chroma of the color in which the three primary colors are mixed may be increased by increasing a luminance of a color having a relatively high color ratio among the three primary colors or reducing a luminance of a color that has a relatively low color ratio.

The color compensation unit 10 may calculate the color ratio based on the luminance of the three primary colors. In addition, the color compensation unit 10 may increase chroma of the color in which the three primary colors are mixed by increasing or reducing the luminance of at least one color, based on the calculated color ratio.

For example, the color compensation unit 10 may select a color with the highest color ratio from among the three primary colors and increase the luminance of the selected color. By increasing the luminance of the color with the highest color ratio among the three primary colors, chroma of the color in which the three primary colors are mixed may be increased, and luminance thereof may also be increased. The higher the color ratio of the selected color, the more the luminance of the color may be increased.

Alternatively, the color compensation unit 10 may increase luminance of a color from among the three primary colors having a color ratio that is equal to or greater than a reference value. The reference value may be a desired value (e.g., a predetermined value) or a value that is adjusted according to an external luminance. Here, the color compensation unit 10 may progressively increase luminance of colors the higher the color ratio is.

According to another embodiment of the present invention, the color compensation unit 10 may select a first color from among the three primary colors having a color ratio equal to or greater than a first reference value and a second color having a color ratio that is less than a second reference value, and increase luminance of the first color and reduce luminance of the second color. In this embodiment of the present invention, the first reference value is greater than the second reference value. The higher the color ratio of the first color, the more an increasing ratio of luminance of a color may become, and the lower the color ratio of the second color, the more a reduction ratio of luminance of a color may become. By increasing the luminance of the first color having a color ratio that is equal to or greater than the first reference value, that is, the first color having a relatively high color ratio, chroma and luminance of the color in which the three primary colors are mixed may be increased. By reducing luminance of a second color having a color ratio less than the second reference value, that is, the second color having a relatively low color ratio, chroma of the color in which the three primary colors are mixed may be increased. In one embodiment, because the color ratio of the second color is relatively low, even though the luminance of the second color is reduced, a reduction amount of the color in which the three primary colors are mixed is small.

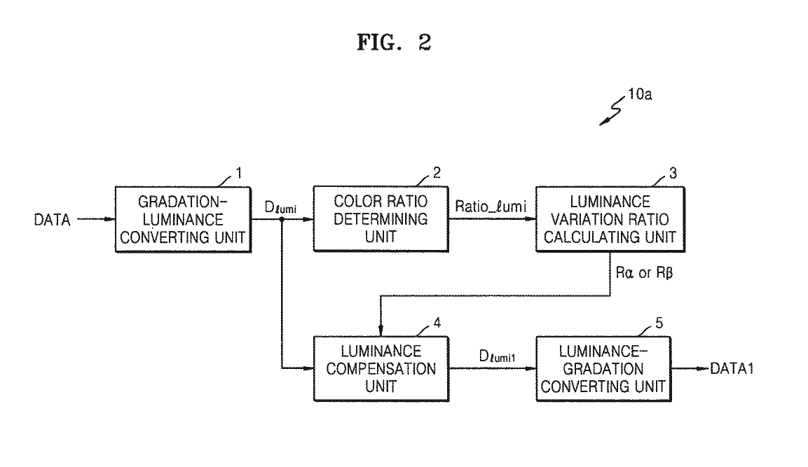

Referring to FIG. 1, the color compensation unit 10 is included in the control unit 120, but it is not limited thereto. The color compensation unit 10 may be separately included from the control unit 120. The color compensation unit 10 will be described in more detail later with reference to FIGS. 2 through 5.

The external light sensing unit 150 may sense the luminance of an external environment around the display device 100, and provide the sensed luminance data to the color compensation unit 10. The color compensation unit 10 may determine whether to perform color compensation on the color data DATA and a degree of the color compensation, based on the sensed luminance data.

The display device 100 may be exposed to various surrounding environments, even more so when the display device 100 is mounted in a portable electronic product, such as a mobile phone or a PDA. Here, the viewability of an image displayed on the display panel 110 of the display device 100 may vary according to external environments factors, such as luminance or color temperature. In particular, if a luminance of the surroundings is higher than the luminance of a display screen (that is, higher than an image displayed on the display panel 110) the viewability of an image displayed on the display panel 110 may decrease abruptly. To improve (or increase) the viewability of an image in an environment with a relatively high luminance, chroma of the image displayed on the display panel 110 may be increased. However, if an RGB color coordinate system is converted to another color coordinate system such as a Ycbcr or HSV coordinate system, and chroma is increased in the converted color coordinate system like in a comparable display device, when the chroma increases, luminance may decrease, and thus viewability may not be materially improved. However, according to the display device 100 of the current embodiment of the present invention, through color compensation for increasing luminance of a color having a relatively high color ratio based on a color ratio of red, green, and blue colors, chroma of a color, in which red, green, and blue colors are mixed (that is, the color that is perceived by a user) may be increased, and thus, chroma and luminance of an image displayed on the display panel 110 may be simultaneously increased. Accordingly, according to the display device 100 of the current embodiment of the present invention, the viewability of an image displayed on the display panel 110 may be increased.

The color compensation unit 10 of FIG. 1 will be described in more detail with reference to FIGS. 2 through 4.

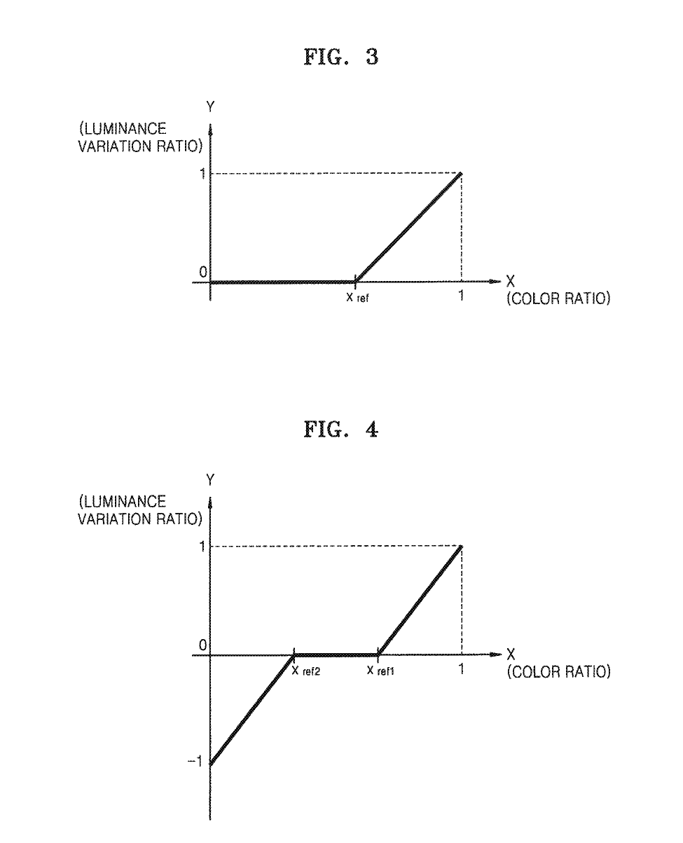

FIG. 2 is a block diagram illustrating a color compensation unit 10a shown in FIG. 1 according to an embodiment of the present invention. FIG. 3 is a graph showing an operation of calculation of a luminance variation ratio according to an embodiment of the present invention. FIG. 4 is a graph showing an operation of calculation of a luminance variation ratio according to another embodiment of the present invention.

Referring to FIG. 2, the color compensation unit (or color compensator) 10a may include a gradation-luminance converting unit (or gradation-luminance converter) 1, a color ratio determining unit (or color ratio determiner) 2, a luminance variation ratio calculating unit (or a luminance variation ratio calculator) 3, a luminance compensation unit (or luminance compensator) 4, and a luminance-gradation converting unit (or luminance gradation converter) 5.

The gradation-luminance converting unit 1 receives color data DATA including gradation data about each of three primary colors of red, green, and blue, and converts the color data DATA to luminance data about each of the three primary colors based on each of the pieces of gradation data. For example, the color data DATA may be a total of 24-bit data, and each piece of 8-bit data may be gradation data of respective red, green, and blue gradation data. The gradation-luminance converting unit 1 converts each piece of 8-bit data corresponding to red, green, and blue to luminance data D lumi, indicating the luminance of each color.

The color ratio determining unit 2 determines a color ratio of each color based on luminance data D_Lumi of three primary colors. The color ratio may be a ratio of luminance data of a color to a sum of luminance data of all the colors. For example, when the luminance of a red color is 100 nit, the luminance of a green color is 50 nit, and the luminance of a blue color is 150 nit, a color ratio of the red color may be 100 nit/(100 nit+50 nit+150 nit), or about 0.33, a color ratio of the green color may be 50 nit/(100 nit+50 nit+150 nit), or about 0.17, and a color ratio of the blue color may be 150 nit/(100 nit+50 nit+150 nit), or about 0.5.

The luminance variation ratio calculating unit 3 calculates a luminance variation ratio Rα or Rβ according to color ratios of the three primary colors. For example, the luminance variation calculating unit 3 may calculate a luminance increasing ratio Rα in order to increase luminance of a color among the three primary colors having a color ratio equal to or greater than a reference value, as illustrated in FIG. 3.

In FIG. 3, an X-axis indicates a color ratio of a color (e.g., a predetermined color), and a Y-axis indicates a luminance variation ratio. A reference value Xref is a reference value for selecting a color of which a luminance is to be increased. Here, the reference value Xref may be determined in advance according to optical characteristics of a display device or may be differently (or variably) set according to an external luminance.

As illustrated in FIG. 3, the higher a color ratio, the more the luminance increasing ratio Rα may increase. When the color ratio is less than the reference value Xref, the luminance variation ratio calculating unit 3 may not increase or decrease luminance, and if the color ratio is equal to or greater than the reference value Xref, the luminance variation ratio calculating unit 3 calculates the luminance increasing ratio Rα for increasing luminance of the color, and here, the higher the color ratio, the more the luminance increasing ratio Rα may increase. Here, the luminance increasing ratio Rα according to a color ratio, that is, a slope of the graph of FIG. 3 may be set according to optical characteristics of the display panel 110.

For example, when a color ratio of red color is 0.33, a color ratio of green color is 0.17, a color ratio of blue color is 0.5, and a reference value Xref is 0.4, the luminance variation ratio calculating unit 3 may calculate the luminance increasing ratio Rα for increasing luminance of the blue color, and the luminance increasing ratio Rα may be higher when a color ratio is relatively high, compared to when a color ratio is relatively low. For example, the luminance increasing ratio Rα may be higher when a color ratio is 0.7, compared to when a color ratio is 0.6.

According to another embodiment, as illustrated in FIG. 4, the luminance variation ratio calculating unit 3 may select a first color among the three primary colors having a color ratio that is equal to or greater than a first reference value Xref1 and calculate a luminance increasing ratio Rα to increase a luminance of the first color, and select a second color among the three primary colors having a color ratio that is equal to or less than a second reference value Xref2 and calculate a luminance reduction ratio Rβ to reduce a luminance of the second color.

In FIG. 4, an X-axis indicates a color ratio of a color (e.g., a predetermined color), and a Y-axis indicates a luminance variation ratio. A first reference value Xref1 is a reference value for selecting a color of which a luminance is to be increased, for example, a first color, and a second reference color Xref2 is a reference value for selecting a color of which a luminance is to be reduced, for example, a second color. Here, the first and second reference values Xref1 and Xref2 may be determined in advance according to optical characteristics of a display device or may be differently (or variably) set according to an external luminance.

As illustrated in FIG. 4, the higher a color ratio of the selected first color, the higher a luminance increasing ratio Rα becomes, and the smaller a color ratio of the selected second color, the higher a luminance reduction ratio Rβ becomes. When all of the color ratios exceed the second reference value Xref2 and are less than the first reference value Xref1, the luminance variation ratio calculating unit 3 does not calculate luminance variation ratios Rα and Rβ. When a color ratio is equal to or greater than the first reference value Xref1, the luminance variation ratio calculating unit 3 selects the color as a first color and calculates a luminance increasing ratio Rα to increase luminance of the first color, and when a color ratio is equal to or smaller than the second reference value Xref2, the luminance variation ratio calculating unit 3 selects the color as a second color and calculates a luminance reduction ratio Rβ to reduce the luminance of the second color. In the current embodiment of the present invention, the higher the color ratio of the first color, the higher the luminance increasing ratio Rα may become, and the smaller the color ratio of the second color, the higher the luminance reduction ratio Rβ may become. In the current embodiment, the luminance increasing ratio Rα according to a color ratio (that is, a slope of the graph of FIG. 4) may be set according to optical characteristics of the display panel 110.

For example, when a color ratio of a red color is 0.33, a color ratio of a green color is 0.17, a color ratio of a blue color is 0.5, the first reference value Xref1 is 0.4, and the second reference value Xref2 is 0.2, the luminance variation ratio calculating unit 3 may select the blue color as the first color of which a luminance is to be increased, and the green color as the second color of which a luminance is to be reduced. The luminance variation ratio calculating unit 3 may calculate the luminance increasing ratio Rα to increase luminance of the blue color, and calculate the luminance reduction ratio Rβ to reduce luminance of the green color. The luminance increasing ratio Rα may be higher when a color ratio is relatively high, compared to when a color ratio is relatively low, and the luminance reduction ratio Rβ may be higher when a color ratio is relatively low, compared to when a color ratio is relatively high. For example, the luminance increasing ratio Rα may be higher when a color ratio is 0.7, compared to when a color ratio is 0.6, and the luminance reduction ratio Rβ may be higher when a color ratio of the green color is 0.1, compared to when a color ratio of the green color is 0.17.

The luminance variation ratio calculating unit 3 may select colors of which luminance are to be increased or reduced based on color ratios of the three primary colors using methods other than the method described above, and calculate the luminance variation ratios Rα and Rβ. For example, the luminance variation ratio calculating unit 3 may select a color with a highest color ratio among the three primary colors and calculate a luminance increase ratio Rα of the selected color. In the current embodiment of the present invention, the higher a color ratio of the selected color, the more the luminance increasing ratio Rα may become.

In another embodiment of the present invention, the luminance variation ratio calculating unit 3 may select a color with the highest color ratio and a color with the lowest color ratio among the three primary colors, and calculate a luminance increasing ratio Rα to increase luminance of the color with the highest color ratio, and may calculate a luminance reduction ratio Rβ to reduce luminance of the color with the lowest color ratio. In this embodiment, the higher the color ratio of the color with the highest color ratio is, the higher the luminance increasing ratio Rα may become, and the lower the color ratio of the color with the lowest color ratio is, the higher the luminance reduction ratio Rβ may become.

Further, referring to FIG. 2, the luminance compensation unit 4 may receive luminance data Dlumi of the three primary colors and the luminance increasing and reduction ratios Rα and Rβ to compensate the luminance of the three primary colors. Here, the luminance compensation unit 4 may apply the luminance increasing ratio Rα to the luminance data of a color of which a luminance is to be increased, for example, the luminance compensation unit 4 may multiply the luminance data by (1+Rα), thereby compensating luminance. Alternatively, the luminance compensation unit 4 may compensate the luminance of the first and second colors by applying a luminance increasing ratio Rα to the luminance data of the first color of which a luminance is to be increased, among the luminance data Dlumi of the three primary colors, and a luminance reduction ratio RP to the second color of which a luminance is to be reduced. For example, the luminance compensation unit 4 may multiply luminance data of the first color by (1+Rα) and multiply luminance data of the second color by (1+Rβ), thereby compensating the luminance of the first and second colors.

The luminance-gradation converting unit 5 converts the compensated luminance data Dlumi1 to gradation data regarding each of the three primary colors, and outputs color data DATA1 including gradation data. The color data DATA1 may be data indicating colors of which chroma and luminosity are increased, compared with the color data DATA received from the outside, through the above-described color compensation.

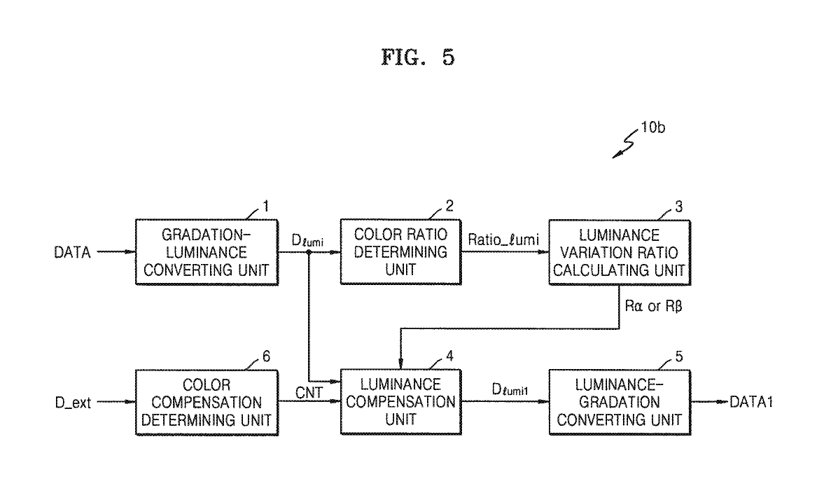

FIG. 5 is a block diagram illustrating a color compensation unit 10b according to another embodiment of the present invention.

Referring to FIG. 5, a color compensation unit 10b includes a gradation-luminance converting unit (or gradation luminance converter) 1, a color ratio determining unit (or color ratio determiner) 2, a luminance variation ratio calculating unit (or luminance variation ratio calculator) 3, a luminance compensation unit (or luminance compensator) 4, a luminance-gradation converting unit (or luminance-gradation converter) 5, and a color compensation determining unit (or color compensation determiner) 6.

Compared to the color compensation unit 10a, the color compensation unit 10b according to the current embodiment of the present invention further includes the color compensation determining unit 6. The gradation-luminance converting unit 1, the color ratio determining unit 2, the luminance variation ratio calculating unit 3, the luminance compensation unit 4, and the luminance-gradation converting unit 5 are described in more detail above, and thus description thereof may be omitted below.

The color compensation unit 6 receives external luminance data D_ext and determines whether to perform color compensation of color data DATA based on the external luminance data D_ext to output a color compensation control signal CNT. The external luminance data D_ext may be provided from the external light sensing unit 150 shown in FIG. 1. The color compensation determining unit 6 may output a color compensation control signal CNT at a first level, for example, a high level, when the external luminance data D_ext exceeds a color compensation reference value (e.g., a predetermined color compensation reference value), and output a color compensation control signal CNT at a second level, for example, a low level, when the external luminance data D_ext is equal to or less than a color compensation reference value (e.g., a predetermined color compensation reference value). The color compensation reference value may be a reference when determining whether color compensation of the display device 100 (FIG. 1) may be performed or not, which may depend on whether external luminance is high or not.

According to the current embodiment of the present invention, in response to the color compensation control signal CNT, the luminance compensation unit 4 may perform or not perform luminance compensation. For example, when the color compensation control signal CNT is at a first level, for example, at a high level, external luminance may be high, and thus the luminance compensation unit 4 may perform luminance compensation. Accordingly, chroma and luminosity of colors displayed on the display panel 110 (FIG. 1) may increase. According to the current embodiment, when the color compensation control signal CNT is at a second level, for example, at a low level, external luminance may be low, and thus, the luminance compensation unit 4 may not perform luminance compensation. Accordingly, colors corresponding to the received color data DATA may be displayed on the display panel 110 without a change.

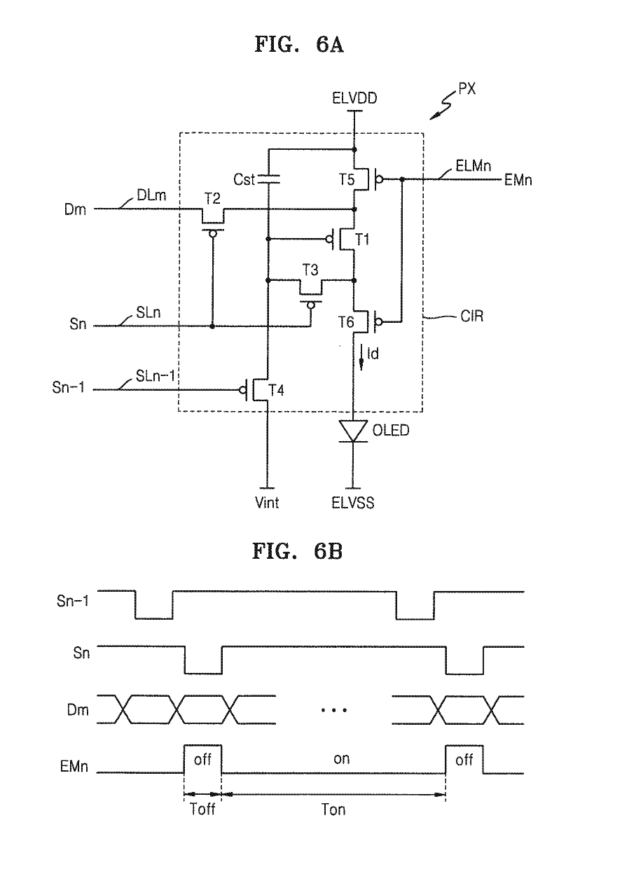

FIG. 6A is a circuit diagram illustrating a pixel PX illustrated in FIG. 1 according to an embodiment of the present invention, and FIG. 6B is a driving waveform diagram of the pixel PX illustrated in FIG. 6A.

Referring to FIGS. 6A and 6B, the pixel PX includes a pixel circuit CR formed of a plurality of transistors T1 through T6, a capacitor Cst, and a light-emitting element such as an organic light emitting diode OLED.

The pixel circuit CR may drive the organic light-emitting diode OLED at a set timing and in a set section by receiving scan signals Sn or Sn-1, a data signal Dm, and an emission control signal EMn. The transistors T1 through T6 may be TFTs. While the transistors T1 through T6 are illustrated as p-type transistors, they may also be n-type transistors and may be driven by reversing a driving waveform of FIG. 6B. Also, according to the current embodiment of the present invention, while the pixel circuit CIR includes six transistors T1 through T6 and one capacitor Cst, the pixel circuit CIR is not limited thereto. The number of transistors and the number of capacitors of the pixel circuit CIR may vary.

The organic light-emitting diode OLED receives a driving voltage from the pixel circuit CIR to emit light by itself. According to the current embodiment of the present invention, while an organic light-emitting diode OLED is included as the light-emitting element, the light-emitting element is not limited thereto. The light-emitting element may be any one of various types of self-emissive light-emitting elements.

During an initialization period, a low-level previous scan signal Sn-1 is supplied through a previous scan line SLn-1. The initialization transistor T4 is turned on according to the low-level previous scan signal Sn-1, and an initialization voltage Vint is provided to a gate of the driving transistor T1 via the initialization transistor T4, and the driving transistor T1 may be initialized via the initialization voltage Vint.

Then, a low-level scan signal Sn is supplied through a scan line SLn during a data programming period. Accordingly, the switching transistor T2 and the compensation transistor T3 may be turned on according to the low-level scan signal Sn.

Here, the driving transistor T1 is diode-coupled (e.g., diode-connected) through the turned-on compensation transistor T3 and is biased in a forward direction.

Then, a compensation voltage Dm+Vth (Vth is a (−) value) which is obtained by subtracting a threshold voltage Vth of the driving transistor T1 from a data signal Dm supplied through the data line DLm, is applied to the gate of the driving transistor T1.

A driving voltage ELVDD and a compensation voltage Dm+Vth are applied to two terminals of the capacitor Cst, and a charge corresponding to a difference between voltages of the two terminals is stored in the capacitor Cst. Then, an emission signal EMn supplied from the emission signal line ELMn during an emission period Ton is converted from a high level to a low level. Then, during the emission period Ton, the operation control transistor T5 and the emission control transistor T6 are turned on according to the emission signal EMn, which is at the low level.

Then, a driving current Id is generated according to a difference between a voltage of the gate of the driving transistor T1 and the driving voltage ELVDD, and the driving current Id is supplied to the organic light-emitting diode OLED via the emission control transistor T6.

During an emission period, a gate-source voltage Vgs of the driving transistor T1 is maintained at {(Dm+Vth)-ELVDD} by using the storage capacitor Cst, and according to a current-voltage relationship of the driving transistor T1, a driving current Id is proportional to a square {(Dm-ELVDD)²} of a value obtained by subtracting a threshold voltage from the gate-source voltage. That is, emission luminance of the organic light-emitting diode OLED may be controlled according to the data signal Dm. Also, emission luminance of the organic light-emitting diode OLED may be controlled by varying the emission period Ton.

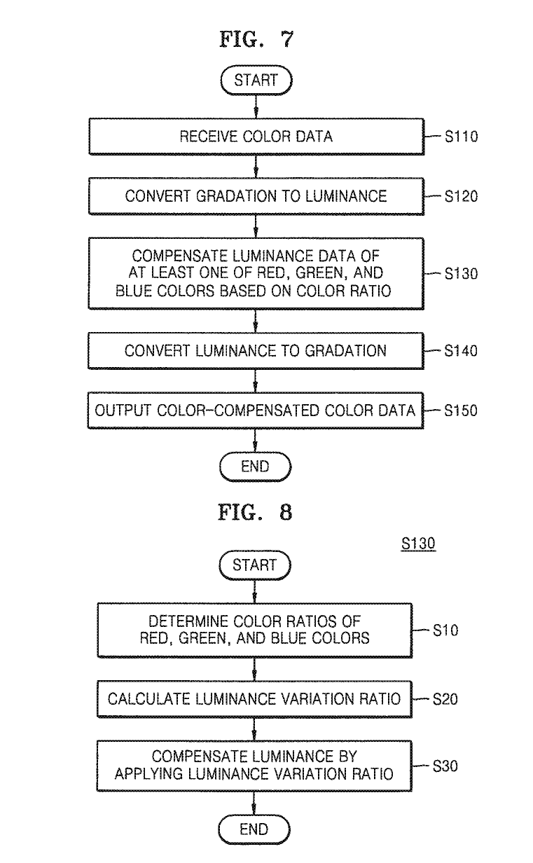

Next, referring to FIGS. 7 and 8, a method of compensating colors of a display device, according to an embodiment of the present invention, will be described. FIG. 7 is a schematic flowchart illustrating a method of compensating colors of a display device, according to an embodiment of the present invention. FIG. 8 is a detailed flowchart illustrating a method of compensating luminance data as described in FIG. 7.

Referring to FIG. 7, the color compensation unit 10 (see FIG. 1) receives color data DATA including gradation data of red, green, and blue colors, that is, three primary colors, which are combined to represent a single color in operation S110. The color data DATA may be provided from outside the display device.

In operation S120, the gradation data of each of the three primary colors is converted to luminance data, and in operation S130, the luminance data of a color among the three primary colors is compensated such that chroma of a color in which the three primary colors are mixed is increased, based on a color ratio of the three primary colors that is calculated by using the luminance data of which the color ratio is converted. In order to compensate the luminance data in operation S130, referring to FIG. 8, a color ratio of each of the three primary colors is determined based on the luminance data of the three primary colors (red, green, and blue colors) in operation S10. The color ratio may be calculated based on a luminance value of a color with respect to a sum of luminance values of the three primary colors. In addition, in operation S20, a luminance variation ratio of at least one of the three primary colors is calculated based on the color ratio. For example, the color compensation unit 10 may select a color having the highest color ratio among the three primary colors, and increase the luminance of the selected color. By increasing the luminance of the color having the highest color ratio among the three primary colors, chroma of a color in which the three primary colors are mixed may be increased. Here, the higher the color ratio of the selected color, the more the luminance of the color may be increased.

Alternatively, the color compensation unit 10 may increase the luminance of a color among the three primary colors with a color ratio that is equal to or greater than a reference value. The reference value may be a set or predetermined value or may be a value adjusted according to an external luminance. Here, the color compensation unit 10 may further increase the luminance of a color the higher a color ratio of the color is.

Alternatively, the color compensation unit 10 may select a first color among the three primary colors having a color ratio equal to or greater than a first reference value and a second color having a color ratio that is less than a second reference value, and increase the luminance of the first color and reduce the luminance of the second color. Here, the higher a color ratio of the first color, the more a luminance increasing ratio of the color may become, and the less a color ratio of the second color, the more a luminance reduction ratio of the color may become.

Then, in operation S30, at least one of the three primary colors is compensated by applying the calculated luminance variation ratio.

Referring to FIG. 7 again, when luminance compensation regarding at least one of the three primary colors is performed, the compensated luminance data is converted to gradation data again in operation S140. Also, in operation S150, color-compensated color data DATA1, that is, color data DATA1 including gradation data of the three primary colors, regarding which luminance is compensated, is output. The color-compensated color data DATA1 may be directly output to the data driver 130 (see FIG. 1) or other image processing may be performed on the color-compensated color data DATA1 and then the color data DATA1 may be output to the data driver 130.

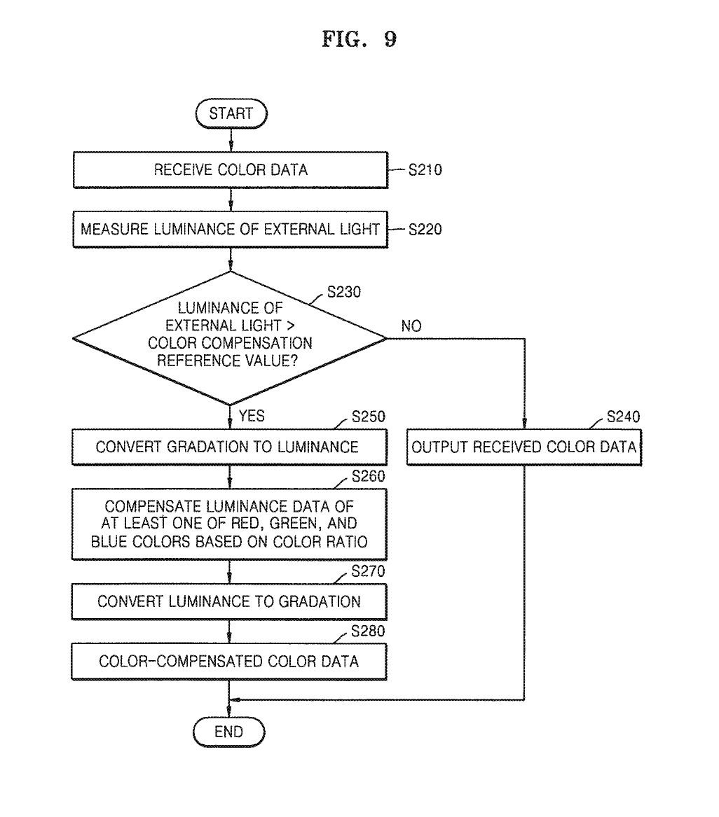

FIG. 9 is a schematic flowchart illustrating a method of compensating colors of a display device according to another embodiment of the present invention.

Compared to the method of compensating colors of FIG. 7, the method illustrated in FIG. 9 may further include measuring external luminance (operation S220), determining whether the measured external luminance is greater than a color compensation reference value (operation S230), and outputting color data DATA received from the outside if the measured external luminance is equal to or less than the color compensation reference value (operation S240). The measuring of external luminance (operation S220) and the determining whether external luminance is greater than a color compensation reference value (operation S230) may be performed after operation S210, in which color data DATA including gradation data of each of the three primary colors (red, green, and blue colors), which are combined to represent a single color, is received. However, the method of the current embodiment of the present invention is not limited thereto. These operations described above may also be performed before receiving color data DATA. External luminance may be measured in the external light sensing unit 150 (see FIG. 1).

If it is determined that external luminance is greater than a color compensation reference value, as described above with reference to FIG. 7, gradation data of each of the three primary colors is converted to luminance data in operation S250. Then, in operation S260, luminance data of at least one of the three primary colors is compensated such that chroma of the color in which the three primary colors are mixed increases based on a color ratio of the three primary colors that is calculated based on luminance data of which the color ratio is converted. Then, the compensated luminance data is converted to gradation data in operation S270, and then in operation S280, the color-compensated color data DATA1, that is, color data DATA1 including gradation data of the three primary colors, regarding which luminance compensation is performed, is output.

However, if it is determined that external luminance is equal to or smaller than a color compensation reference value, color data DATA received from the outside may be output to the data driver 130 without color compensation, in operation S240. That is, in the current embodiment, before performing color compensation, external luminance is measured, and if it is determined that external luminance is not relatively high, an image corresponding to the received color data DATA is displayed on the display panel 110 (see FIG. 1) without a change, and if it is determined that external luminance is relatively high, color compensation is performed in order to increase chroma and luminosity of an image displayed on the display panel 110, thereby increasing the viewability of the image.

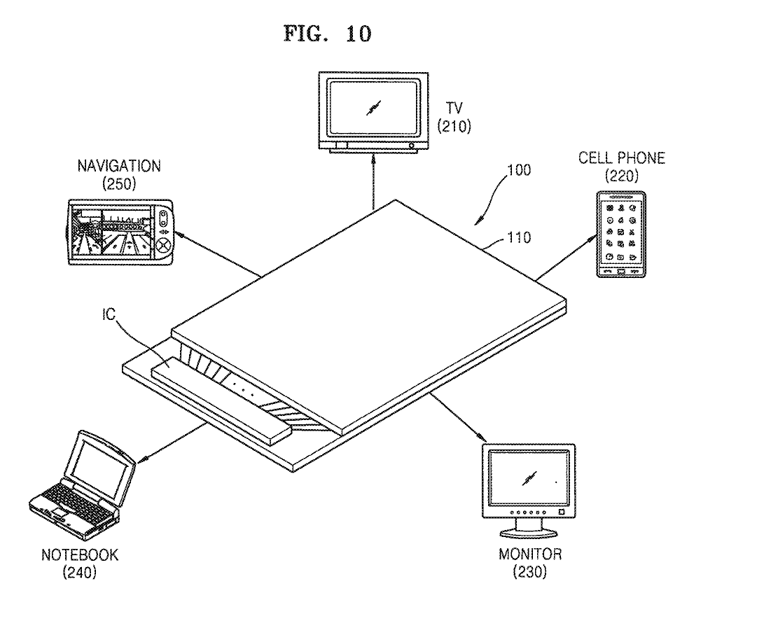

FIG. 10 illustrates an application example of various electronic products in which a display device 100 according to an embodiment of the present invention is mounted.

The display device 100 may be used in a TV 210, or may also be widely used in a mobile phone 220, a monitor 230, a laptop computer 240, or a navigation device 250. Moreover, the display device 100 may be used in any electronic device where a display device is used. Referring to FIG. 10, while the display device 100 includes driving circuits (i.e., the control unit 120, the data driver 130, and the scan driver 140 (see FIG. 1)) that drive the display panel 110 in a single integrated chip (IC), the display device 100 is not limited thereto. When the display device 100 is large, such as those included in the TV 210, the monitor 230, or the laptop computer 240, driving circuits may be integrated in different chips, and the display device 100 may include a plurality of ICs.

As the display device 100 is commercialized in electronic devices of various fields, a display device having an improved (or increased) image quality is desired. In an environment with a high external luminance such as outdoors on a sunny day, the viewability of images displayed on the display panel 100 should be high. According to the display device 100 of embodiments of the present invention, chroma and luminosity of a color, in which red, green, and blue colors are mixed, are increased based on color ratios of the red, green, and blue colors, thereby increasing the viewability of an image displayed on the display panel 110 in an environment with a high external luminance.

While the present invention has been particularly shown and described with reference to exemplary embodiments thereof, it will be understood by those of ordinary skill in the art that various changes in form and details may be made therein without departing from the spirit and scope of the present invention as defined by the following claims, and equivalents thereof.

What is claimed is:

1. A display device comprising:
a display panel comprising a plurality of pixels, each of the plurality of pixels configured to display one of three primary colors; and
a color compensator configured to receive color data comprising gradation data corresponding to each of the three primary colors and configured to increase chroma of a color, in which the three primary colors are mixed, by compensating a color of the color data based on color ratios of the three primary colors.

2. The display device of claim 1, wherein the color compensator is configured to calculate the color ratios based on luminance values of the three primary colors.

3. The display device of claim 1, wherein the color compensator is configured to select a color having a highest color ratio among the three primary colors and to increase a luminance of the selected color.

4. The display device of claim 3, wherein the color compensator is configured to progressively increase the luminance of the selected color as the color ratio of the selected color increases.

5. The display device of claim 1, wherein the color compensator is configured to increase a luminance of a color among the three primary colors having a color ratio equal to or greater than a reference value.

6. The display device of claim 5, wherein the color compensator is configured to progressively increase the luminance of the color as the color ratio of the color having the color ratio equal to or greater than the reference value increases.

7. The display device of claim 5, wherein the reference value is a predetermined value or a value set according to an external luminance.

8. The display device of claim 1, wherein the color compensator is configured to increase a luminance of a first color among the three primary colors having a color ratio equal to or greater than a first reference value, and configured to reduce a luminance of a second color having a color ratio equal to or less than a second reference value less than the first reference value.

9. The display device of claim 8, wherein the color compensator is configured to increase the luminance of the first color as the color ratio of the first color increases, and configured to reduce the luminance of the second color as the color ratio of the second color decreases.

10. The display device of claim 1, further comprising an external light sensor configured to sense an external luminance.

11. The display device of claim 10, wherein the color compensator is configured to perform color compensation of the color data when external luminance data provided from the external light sensor is equal to or greater than a reference value.

12. The display device of claim 1, wherein each of the plurality of pixels comprises an organic light-emitting diode.

13. A display device comprising:
a display panel comprising a plurality of pixels, each of the plurality of pixels configured to display one of a plurality of colors comprising red, green, and blue colors;
a data driver configured to provide pixel data corresponding to received color data to the display panel;
an external light sensor configured to sense an external luminance; and
a controller configured to receive color data comprising gradation data corresponding to each of the plurality of colors, and configured to perform image processing on the color data and to output the color data to the data driver,
wherein the controller comprises a color compensator configured to compensate a color of the color data by increasing chroma of a color in which the plurality of colors are mixed based on color ratios of the plurality of colors.

14. The display device of claim 13, wherein the color compensator is configured to increase a luminance of a color among the plurality of colors having a color ratio equal to or greater than a reference value.

15. The display device of claim 13, wherein the controller and the data driver are integrated as a single semiconductor chip.

16. A method of compensating a color of a display device, the method comprising:
receiving color data comprising gradation data of each of three primary colors comprising red, green, and blue colors mixed to form a single color;
converting the gradation data of each of the three primary colors to luminance data;
compensating luminance data of at least one color among the three primary colors such that chroma of the single color increases based on color ratios of the three primary colors calculated using the luminance data;
converting the compensated luminance data to gradation data; and
outputting color-compensated color data.

17. The method of claim 16, wherein the compensating luminance data comprises:
determining color ratios of the three primary colors;
calculating a luminance variation ratio of the at least one color based on the color ratios; and
compensating a luminance of the at least one color by applying the luminance variation ratio.

18. The method of claim 17, wherein in the calculating a luminance variation ratio, an increasing ratio is calculated with respect to a color among the three primary colors having a color ratio equal to or greater than a reference value, such that the luminance is progressively increased as a color ratio increases.

19. The method of claim 17, wherein in the calculating a luminance variation ratio, a luminance increasing ratio by which the luminance is progressively increased as a color ratio increases, with respect to a first color among the three primary colors having a color ratio equal to or greater than a first reference value, and a luminance reduction ratio by which luminance is progressively reduced as a color ratio decreases, with respect to a second color having a color ratio equal to or less than a second reference value lower than the first reference value, are calculated.

20. The method of claim 16, further comprising measuring an external luminance,
wherein the compensating luminance data is performed when the measured external luminance is equal to or greater than a reference value.
